(19) United States
(12) Patent Application Publication
(10) Pub. No.: US 2020/0356581 A1
(43) Pub. Date: Nov. 12, 2020

(54) ISOCHRONE-BASED ESTIMATION OF TRANSIT TIMES

(71) Applicant: Microsoft Technology Licensing, LLC, Redmond, WA (US)

(72) Inventors: Austin Q. Lu, Sunnyvale, CA (US); Caleb T. Johnson, Village of Lakewood, IL (US); Dezhen Li, San Francisco, CA (US); Minh Tu A. Nguyen, San Jose, CA (US)

(73) Assignee: Microsoft Technology Licensing, LLC, Redmond, WA (US)

(21) Appl. No.: 16/406,567

(22) Filed: May 8, 2019

(51) Int. Cl. G06F 16/29; G06F 16/9035; G01C 21/34

(52) U.S. Cl. CPC G06F 16/29; G01C 21/3492; G06F 16/9035

(57) ABSTRACT

The disclosed embodiments provide a system for estimating transit times. During operation, the system selects one or more transit time thresholds that fall within a transit time preference for a user. Next, the system obtains one or more isochrones representing the one or more transit time thresholds for a starting point associated with the user and a mode of transportation. The system then compares locations of a set of entities to the one or more isochrones to calculate transit times between the starting point and the set of entities. Finally, the system outputs, based on the transit times, one or more recommendations comprising one or more entities in the set of entities that meet the transit time preference.

### RELATED APPLICATION

The subject matter of this application is related to the subject matter in a co-pending non-provisional application filed on the same day as the instant application, entitled “Searching by Commute Preference,” having serial number TO BE ASSIGNED, and filing date TO BE ASSIGNED (Attorney Docket No. LI-902497-US-NP).

### BACKGROUND

### Field

The disclosed embodiments relate to techniques for determining transit times. More specifically, the disclosed embodiments relate to techniques for performing isochrone-based estimation of transit times.

### Related Art

Online networks commonly include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be tracked and/or maintained on web-based networking services, such as online networks that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals may use an online network to locate prospects, maintain a professional image, establish and maintain relationships, and/or engage with other individuals and organizations. Similarly, recruiters may use the online network to search for candidates for job opportunities and/or open positions. At the same time, job seekers may use the online network to enhance their professional reputations, conduct job searches, reach out to connections for job opportunities, and apply to job listings.

To many job seekers, commute time to a prospective job is an important factor in the attractiveness of the job. For example, a job seeker may have a maximum “tolerable” commute time to a new job, which restricts the set of jobs the job seeker would consider, given the job seeker's current place of residence and/or additional locations in which the job seeker would consider living. The job seeker may also, or instead, be willing to consider lower-paying jobs with shorter commute times, in lieu of or in addition to higher-paying jobs with longer commute times.

However, conventional job search tools, employment websites, and/or other services or solutions for hiring and/or job-seeking typically allow job seekers to search for jobs by location without assessing how the jobs' locations relate to the job seekers' commute times. As a result, jobs returned as results of a job seeker's location-based search frequently vary greatly in commute time with respect to the job seeker's current or preferred place of residence. Because the jobs lack commute information, the job seeker may be required to assess his/her commute time to individual jobs by manually searching for routes and/or directions between his/her current or preferred place of residence and the location of each job using a mapping, navigation, and/or route planning tool.

Moreover, when posted jobs lack readily available commute information for job seekers, posters of the jobs can receive applications from job seekers that would otherwise be deterred by commute times to the jobs. Consequently, both the job posters and job seekers may expend unnecessary time and effort in interacting with one another before discovering that the jobs' locations are not a good fit for the job seekers' commute preferences.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3A shows an example set of map tiles related to a geographic area of a polygon in accordance with the disclosed embodiments.

FIG. 3B shows an example set of map tiles related to a geographic area of a polygon in accordance with the disclosed embodiments.

FIG. 3C shows an example prefix tree representation of a set of map tiles in accordance with the disclosed embodiments.

FIG. 3D shows an example prefix tree representation of an index in accordance with the disclosed embodiments.

FIG. 4 shows a flowchart illustrating a process of searching by commute preference in accordance with the disclosed embodiments.

FIG. 5 shows a flowchart illustrating a process of identifying map tiles that cover a geographic area of a polygon in accordance with the disclosed embodiments.

FIG. 6 shows a flowchart illustrating a process of searching a representation of map tiles for jobs with locations in a geographic area represented by the map tiles in accordance with the disclosed embodiments.

FIG. 7 shows a flowchart illustrating a process of estimating transit times between a candidate and a set of jobs in accordance with the disclosed embodiments.

FIG. 8 shows a flowchart illustrating a process of using isochrones to determine transit times between a candidate and a set of jobs in accordance with the disclosed embodiments.

FIG. 9 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for identifying and/or filtering entities based on transit times to or from the entities. In some embodiments, the transit times include commute times from a current or preferred place of residence, and the entities include jobs for which the commute times are evaluated.

More specifically, the disclosed embodiments provide a method, apparatus, and system for performing isochrone-based estimation of transit times. In some embodiments, a transit time preference for a user (e.g., a job candidate's maximum tolerable commute time) is used to generate one or more isochrones. Each isochrone includes one or more polygons representing one or more geographic areas that can be reached within a certain amount of time from a starting point associated with the candidate (e.g., the candidate's current and/or preferred place of residence) and/or using a preferred method of transportation for the candidate. For example, a maximum commute time of 60 minutes may result in isochrones representing 15, 30, 45, and/or 60 minutes of travel from the candidate's home by foot, bicycle, public transit, car, and/or other mode of transportation.

Next, locations of jobs (or other entities) are compared to the isochrones to determine transit times between the starting point and the jobs. The comparison begins with a first isochrone that represents the smallest time threshold; during the comparison, a ray-casting technique and/or another technique for determining inclusion of a point in a polygon or exclusion of a point from the polygon is used to identify a first subset of jobs located within the first isochrone. In turn, the first subset of jobs is assigned a transit time that is equal to the smallest time threshold. The process then repeats with remaining isochrones that are ordered by ascending time threshold and remaining jobs that are identified to lie outside previous isochrones. At the end of the process, a set of jobs that meet the candidate's transit time preference is identified. Within the set of jobs, each job is assigned a transit time that represents the lowest time threshold isochrone in which the job is found.

The identified jobs and/or corresponding transit times are used to generate and/or output recommendations related to the candidate's transit time preference. In one exemplary embodiment, the recommendations include a list of jobs that meet the candidate's transit time preference and/or other parameters provided by the candidate in a job search. In another exemplary embodiment, the recommendations include a transit time calculated for a job using the process described above.

By using isochrones related to a candidate's transit time preference to identify jobs with transit times that meet the transit time preference, the disclosed embodiments allow job searches and/or job recommendations related to the candidate to reflect the candidate's commute preferences. In turn, the candidate is able to avoid manual lookup of routes to the jobs to determine commute times for the jobs. At the same time, the use of isochrones to estimate transit times between starting points associated with users (e.g., candidates) and entities (e.g., jobs) enables scaling of the estimates to a large number of user-entity pairs. Consequently, the disclosed embodiments improve computer systems, applications, user experiences, tools, and/or technologies related to location-based search, route planning, user recommendations, employment, recruiting, and/or hiring.

### Isochrone-Based Estimation of Transit Times

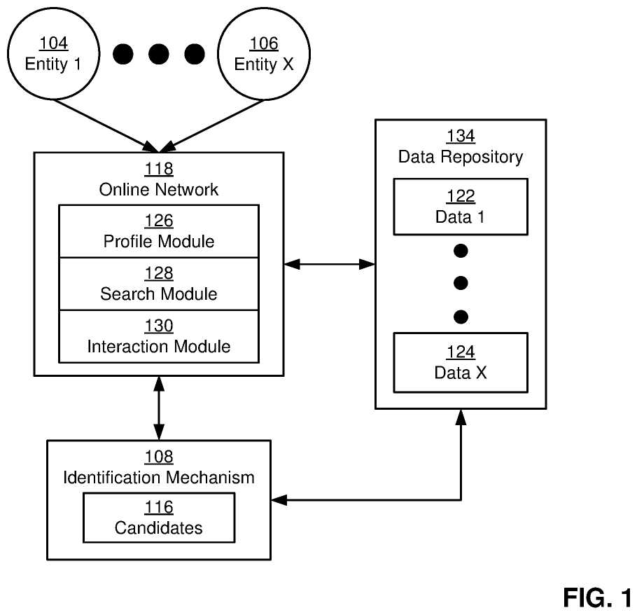

FIG. 1 shows a schematic of a system in accordance with the disclosed embodiments. As shown in FIG. 1, the system includes an online network 118 and/or other user community. For example, online network 118 includes an online professional network that is used by a set of entities (e.g., entity 1 104, entity m 106) to interact with one another in a professional and/or business context.

The entities include users that use online network 118 to establish and maintain professional connections, list work and community experience, endorse and/or recommend one another, search and apply for jobs, and/or perform other actions. The entities also, or instead, include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 also allows the entities to view the profiles of other entities in online network 118.

Profile module 126 also, or instead, includes mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data n 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 may be tracked and stored in a database, data warehouse, cloud storage, and/or other data-storage mechanism providing data repository 134.

Data in data repository 134 is then used to generate recommendations and/or other insights related to listings of jobs or opportunities within online network 118. For example, one or more components of online network 118 may track searches, clicks, views, text input, conversions, and/or other feedback during the entities' interaction with a job search tool in online network 118. The feedback may be stored in data repository 134 and used as training data for one or more machine learning models, and the output of the machine learning model(s) may be used to display and/or otherwise recommend a number of job listings to current or potential job seekers in online network 118.

More specifically, data in data repository 134 and one or more machine learning models are used to produce rankings of candidates associated with jobs or opportunities listed within or outside online network 118. As shown in FIG. 1, an identification mechanism 108 identifies candidates 116 associated with the opportunities. For example, identification mechanism 108 may identify candidates 116 as users who have viewed, searched for, and/or applied to jobs, positions, roles, and/or opportunities, within or outside online network 118. Identification mechanism 108 may also, or instead, identify candidates 116 as users and/or members of online network 118 with skills, work experience, and/or other attributes or qualifications that match the corresponding jobs, positions, roles, and/or opportunities.

In some embodiments, after candidates 116 (e.g., users that are applicants or prospective applicants for jobs posted in online network 118) are identified, profile and/or activity data of candidates 116 are inputted into the machine learning model(s), along with features and/or characteristics of the corresponding opportunities (e.g., required or desired skills, education, experience, industry, title, etc.). In turn, the machine learning model(s) output scores representing the strengths of candidates 116 with respect to the opportunities and/or qualifications related to the opportunities (e.g., skills, current position, previous positions, overall qualifications, etc.). For example, the machine learning model(s) may generate scores based on similarities between the candidates' profile data with online network 118 and descriptions of the opportunities. The model(s) may further adjust the scores based on social and/or other validation of the candidates' profile data (e.g., endorsements of skills, recommendations, accomplishments, awards, patents, publications, reputation scores, etc.). The rankings may then be generated by ordering candidates 116 by descending score.

In turn, rankings based on the scores and/or associated insights are used to improve the quality of candidates 116 (e.g., the extent to which candidates 116 meet requirements or qualifications of jobs in online network 118), recommendations of opportunities to candidates 116, and/or recommendations of candidates 116 for opportunities. Such rankings are also, or instead, used to increase user activity with online network 118 and/or guide the decisions of candidates 116 and/or moderators involved in screening for or placing the opportunities (e.g., hiring managers, recruiters, human resources professionals, etc.).

For example, one or more components of online network 118 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings for a set of jobs during ordering of the jobs as search results in response to a job search by the job candidate. In a third example, the component(s) may output a ranking of job candidates for a given set of job qualifications as search results to a recruiter after the recruiter performs a search with the job qualifications included as parameters of the search. In a fourth example, the component(s) may output a ranking of jobs as search results to a job candidate after the job candidate specifies one or more attributes of the jobs in a job search. In a fifth example, the component(s) may recommend jobs to a candidate based on the predicted relevance or attractiveness of the jobs to the candidate and/or the candidate's likelihood of applying to the jobs.

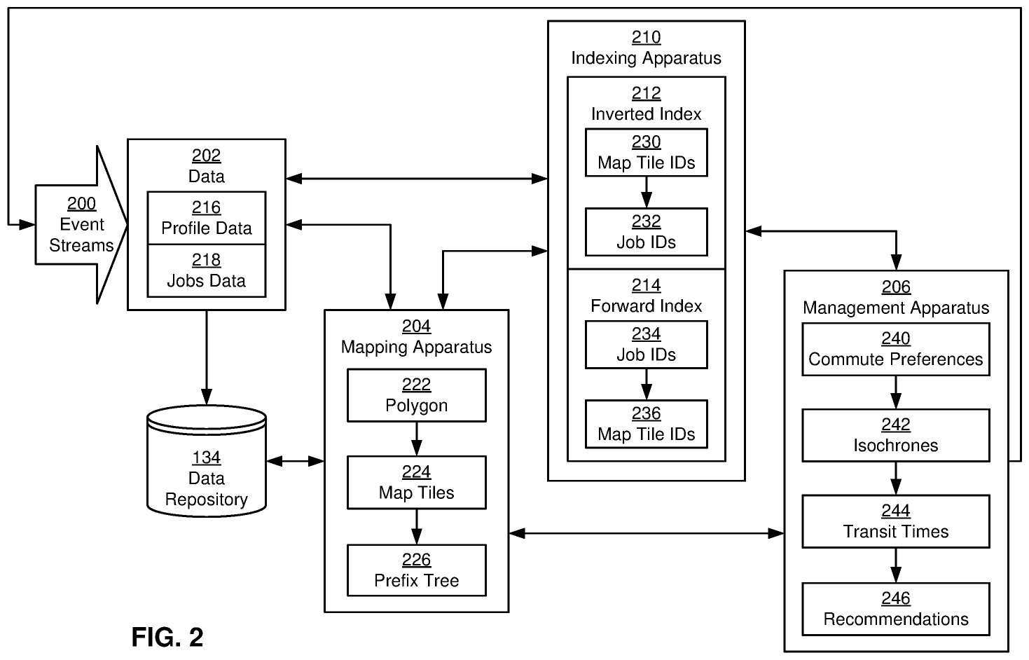

In one or more embodiments, online network 118 includes functionality to improve job-seeking and/or hiring activity by including commute times as parameters and/or factors in searches, rankings, and/or recommendations related to candidates 116 and/or opportunities. As shown in FIG. 2, data repository 134 and/or another primary data store may be queried for data 202 that includes profile data 216 for members of an online network (e.g., online network 118 of FIG. 1), as well as jobs data 218 for jobs that are listed or described within or outside the online network.

Profile data 216 includes data associated with member profiles in the online network. For example, profile data 216 for an online professional network includes a set of attributes for each user, such as (but not limited to) demographic (e.g., gender, age range, nationality, location, language), professional (e.g., job title, professional summary, employer, industry, experience, skills, seniority level, professional endorsements), social (e.g., organizations of which the user is a member, geographic area of residence), and/or educational (e.g., degree, university attended, certifications, publications) attributes. Profile data 216 also, or instead, includes a set of groups to which the user belongs, the user's contacts and/or connections, awards or honors earned by the user, licenses or certifications attained by the user, patents or publications associated with the user, and/or other data related to the user's interaction with the platform.

In one embodiment, attributes of the members from profile data 216 are matched to a number of member segments, with each member segment containing a group of members that share one or more common attributes. For example, member segments in the online network may be defined to include members with the same industry, title, location, and/or language.

In one embodiment, connection information in profile data 216 is combined into a graph, with nodes in the graph representing entities (e.g., users, schools, companies, locations, etc.) in the online network. Edges between the nodes in the graph represent relationships between the corresponding entities, such as connections between pairs of members, education of members at schools, employment of members at companies, following of a member or company by another member, business relationships and/or partnerships between organizations, and/or residence of members at locations.

Jobs data 218 includes structured and/or unstructured data for job listings and/or job descriptions that are posted and/or provided by members of the online network. For example, jobs data 218 for a given job or job listing include, but is not limited to, a declared or inferred title, company, required or desired skills, responsibilities, qualifications, role, location, industry, seniority, salary range, benefits, education level, and/or member segment.

In one or more embodiments, data repository 134 stores data 202 that represents standardized, organized, and/or classified attributes. For example, skills in structured jobs data 216 and/or unstructured jobs data 218 are organized into a hierarchical taxonomy that is stored in data repository 134. The taxonomy models relationships between skills and/or sets of related skills (e.g., “Java programming” is related to or a subset of “software engineering”) and/or standardize identical or highly related skills (e.g., “Java programming,” “Java development,” “Android development,” and “Java programming language” are standardized to “Java”).

In another example, locations in data repository 134 include cities, metropolitan areas, states, countries, continents, and/or other standardized geographical regions. Like standardized skills, the locations are optionally be organized into a hierarchical taxonomy (e.g., cities are organized under states, which are organized under countries, which are organized under continents, etc.).

In a third example, data repository 134 includes standardized company names for a set of known and/or verified companies associated with the members and/or jobs. In a fourth example, data repository 134 includes standardized titles, seniorities, and/or industries for various jobs, members, and/or companies in the online network. In a fifth example, data repository 134 includes standardized time periods (e.g., daily, weekly, monthly, quarterly, yearly, etc.) that can be used to retrieve profile data 216, jobs data 218, and/or other data 202 that is represented by the time periods (e.g., starting a job in a given month or year, graduating from university within a five-year span, job listings posted within a two-week period, etc.). In a sixth example, data repository 134 includes standardized job functions such as “accounting,” “consulting,” “education,” “engineering,” “finance,” “healthcare services,” “information technology,” “legal,” “operations,” “real estate,” “research,” and/or “sales.”

In some embodiments, standardized attributes in data repository 134 are represented by unique identifiers (IDs) in the corresponding taxonomies. For example, each standardized skill is represented by a numeric skill ID in data repository 134, each standardized title is represented by a numeric title ID in data repository 134, each standardized location is represented by a numeric location ID in data repository 134, and/or each standardized company name (e.g., for companies that exceed a certain size and/or level of exposure in the online system) is represented by a numeric company ID in data repository 134.

Data 202 in data repository 134 is updated using records of recent activity received over one or more event streams 200. For example, event streams 200 are generated and/or maintained using a distributed streaming platform such as Apache Kafka (Kafka™ is a registered trademark of the Apache Software Foundation). One or more event streams 200 are also, or instead, provided by a change data capture (CDC) pipeline that propagates changes to data 202 from a source of truth for data 202. For example, an event containing a record of a recent profile update, job search, job view, job application, response to a job application, connection invitation, post, like, comment, share, and/or other recent member activity within or outside the community is generated in response to the activity. The record is then propagated to components subscribing to event streams 200 on a near-realtime basis.

A management apparatus 206 obtains one or more commute preferences 240 for a candidate. In one or more embodiments, commute preferences 240 include parameters related to a commute the candidate is willing to take to a new or potential job. For example, management apparatus 206 includes functionality to generate a user interface that allows each candidate to specify a starting point (e.g., the candidate's current or preferred place of residence), a start time of a commute (e.g., a time of day and/or day of the week), an amount of time the candidate is willing to spend on the commute (e.g., a number of minutes and/or hours), a preferred mode of transportation used in the commute (e.g., walking, cycling, public transit, driving, etc.), and/or other commute preferences 240.

Management apparatus 206 uses commute preferences 240 to estimate transit times 244 between the candidate and a set of jobs and/or generate recommendations 246 based on transit times 244. First, management apparatus 206 obtains and/or produces one or more isochrones 242 related to commute preferences 240. Each isochrone is associated with a transit time threshold that is less than or equal to the maximum time the candidate is willing to spend commuting.

In one embodiment, each transit time threshold includes a numeric value denote a number of minutes, hours, and/or other units of time spent on the candidate's commute. For example, management apparatus 206 obtains predefined transit time thresholds of 15 minutes, 30 minutes, 45 minutes, and/or 60 minutes for a 60-minute maximum commute time in commute preferences 240. In another example, management apparatus 206 generates a single transit time threshold representing a maximum commute time that is 15 minutes or less. In a third example, management apparatus 206 selects the number of transit time thresholds and/or the spacing in between consecutive transit time thresholds based on the value of the maximum commute time, additional values of “preferred” commute time from the same candidate, and/or additional values of maximum or preferred commute time from other candidates. In a fourth example, management apparatus 206 generates one or more transit time thresholds based on the candidate's preferred method of transportation, as specified in commute preferences 240.

After transit time thresholds are defined with respect to the candidate's maximum and/or preferred commute time, management apparatus 206 obtains isochrones 242 representing geographic boundaries for the transit time thresholds with respect to one or more starting points, one or more methods of transportation, and/or one or more starting times specified in commute preferences 240. To produce isochrones 242, management apparatus 206 and/or another component retrieves transit schedules, historical traffic patterns, and/or other data related to the candidate's specified method of transportation, starting point, and/or starting time in commute preferences 240. The component then generates each isochrone as one or more polygons (e.g., polygon 222) representing geographic areas reachable within the corresponding transit time threshold from the starting point, at the starting time, and/or using the method of transportation.

Those skilled in the art will appreciate that individual isochrones 242 can include varying numbers and/or arrangements of polygons. In one example, an isochrone representing a time boundary associated with travel using public transportation includes a series of polygons representing locations that can be reached from individual stops of a train, bus, or other publicly accessible conveyance. In another example, an isochrone representing a time boundary associated with car travel includes a ring shape that is formed along a freeway and/or other high-speed road.

After isochrones 242 are generated based on commute preferences 240, management apparatus 206 identifies a set of jobs that meet the candidate's commute preferences 240 by comparing locations of the jobs with geographic representations of commute preferences 240. In one or more embodiments, each geographic representation of a candidate's commute preferences 240 includes a corresponding polygon 222 that covers an area within a map. For example, as discussed above, the geographic representations of commute preferences 240 include one or more polygonal isochrones 242 representing locations that can be reached during a commute that meets commute preferences 240. The geographic representations also, or instead, include a user-specified polygon 222, such as a custom shape drawn by the candidate that represents a geographic “area of interest” within which the candidate would like to search for jobs.

To reduce overhead associated with storing and/or using complex polygon 222 representations of commute preferences 240, management apparatus 206 limits the number of vertices in each isochrone and/or other polygon 222 representations of commute preferences 240. In one embodiment, management apparatus 206 sets a maximum number of vertices for each polygon 222 to meet a size limitation for storing the polygon in an entry within a data store. When the number of vertices in a given isochrone and/or other polygon 222 exceeds the maximum number of vertices, management apparatus 206 downsamples the vertices in the polygon to fall within the maximum number. For example, management apparatus 206 uses a Douglas-Peucker technique, Visvalingam-Whyatt technique, and/or another line-simplification technique to reduce the number of vertices in the polygon while maintaining reasonable accuracy in the shape of the polygon.

In one or more embodiments, management apparatus 206 performs efficient retrieval of jobs that meet commute preferences 240 using a prefix tree 226 representation of a geographic area covered by a given polygon 222, as well as one or more indexes that store mappings between the jobs and locations of the jobs. As shown in FIG. 2, a mapping apparatus 204 generates prefix tree 226 from polygon 222 as supplied by management apparatus 206 or another component, and an indexing apparatus 210 produces an inverted index 212 and a forward index 214 that are compared with prefix tree 226 to identify jobs that are located within polygon 222.

In one embodiment, prefix tree 226 stores a representation of a set of map tiles 224 that substantially cover the geographic area of polygon 222. Each map tile covers a certain area within a map and is assigned a corresponding map tile identifier (ID) (e.g., map tile IDs 230 and 236). For example, map tiles 224 may include contiguous square regions within a Mercator projection of the world, with each map tile further divisible into four smaller map tiles 224 that occupy the four quadrants of the map tile. The ID of the larger map tile additionally serves as a prefix for the ID of each smaller map tile that is contained within the larger map tile. Thus, inclusion of a first map tile within a second, larger map tile can be verified by comparing the prefix of the first map tile's ID with the ID of the second map tile.

To generate prefix tree 226, mapping apparatus 204 recursively divides larger map tiles 224 encompassing polygon 222 into smaller map tiles 224 and compares each map tile to the area covered by polygon 222. When a given map tile is found entirely within polygon 222, mapping apparatus 204 adds the map tile to prefix tree 226. When a map tile is found entirely outside polygon 222, mapping apparatus 204 omits the map tile from prefix tree 226 and discontinues further subdivision of the map tile. When a map tile is partially intersected by polygon 222, mapping apparatus 204 divides the map tile into additional smaller map tiles 224 and repeats the comparison with the smaller map tiles 224. When a minimum map tile size is reached, mapping apparatus 204 applies a threshold to the area of each map tile covered by polygon 222 to determine if the map tile should be included in prefix tree 226 or excluded from prefix tree 226.

Indexing apparatus 210 generates inverted index 212 to include mappings of map tile IDs 230 to job IDs 232 of jobs in data repository 134. As a result, inverted index 212 allows retrieval of one or more jobs with locations that are found in and/or overlap with a certain map tile ID. In one embodiment, inverted index 212 includes a prefix tree representation of map tile IDs 230 to expedite identification of jobs that are located in map tiles 224 represented by prefix tree 226.

Indexing apparatus 210 also generates forward index 214 to include mappings of job IDs 234 of the jobs to map tile IDs 236. Thus, forward index 214 allows retrieval of one or more map tiles representing a job's location, given the job's ID.

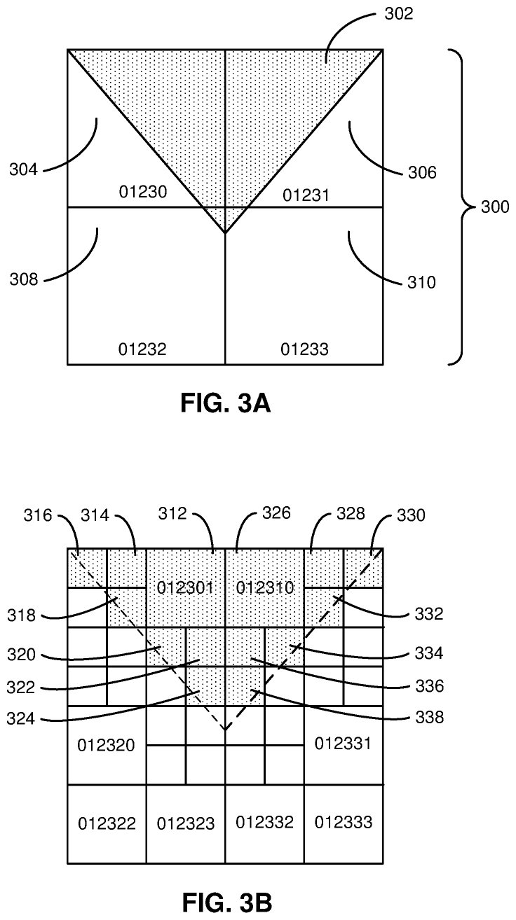

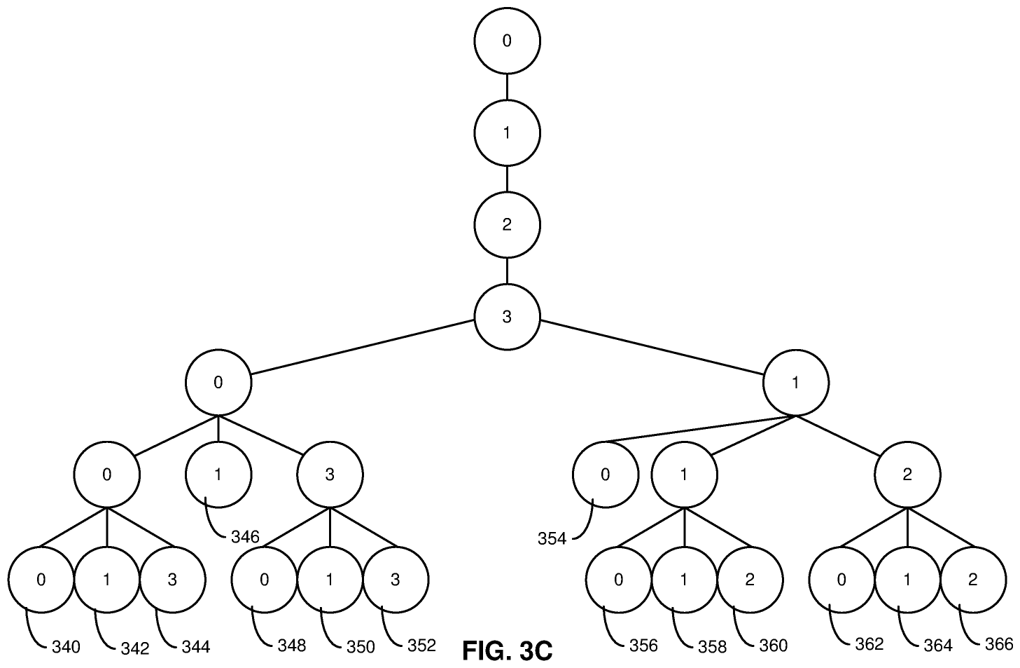

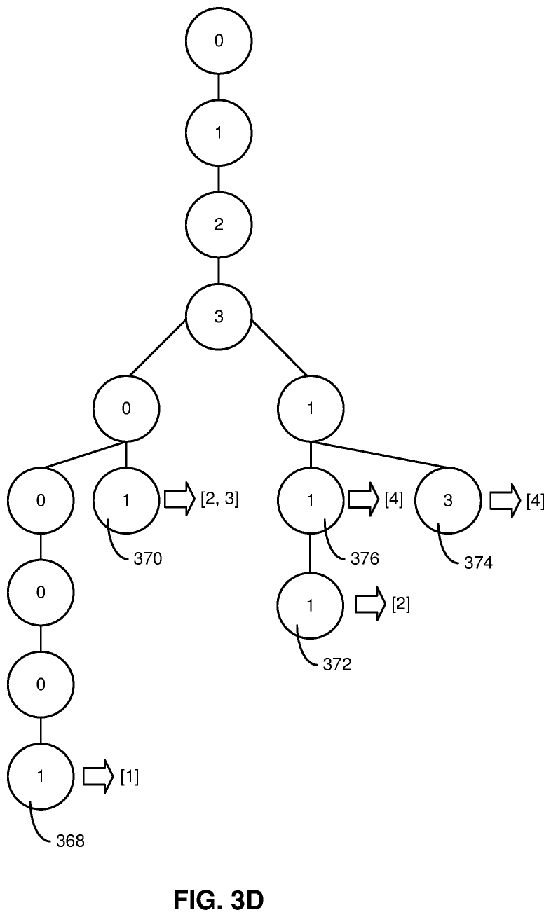

The operation of mapping apparatus 204, indexing apparatus 210, and management apparatus 206 is described with respect to the example structures illustrated in FIGS. 3A-3D. As shown in FIG. 3A, mapping apparatus 204 identifies a square map tile 300 fully enclosing a polygon 302. For example, mapping apparatus 204 compares the locations of the vertices of polygon 302 with the boundaries of map tile 300 to determine that all vertices of polygon 302 are found within map tile 300.

As mentioned above, polygon 302 represents an isochrone and/or other geographic boundary for a candidate's commute preference and/or job search preference. A substantially triangular shape of polygon 302 is optionally produced after a number of additional vertices have been removed from an original polygon by a line-simplification technique.

Mapping apparatus 204 divides map tile 300 into four smaller map tiles 302-310. In the example shown in FIG. 3A, map tile 300 has an ID of 0123, which is the prefix for the IDs of 01230, 01231, 01232, and 01233 for map tiles 304, 306, 308, and 310, respectively. Because all four map tiles 304-310 overlap partially with polygon 302 (e.g., based on intersections of the edges of map tiles 304-310 with the edges of polygon 302), mapping apparatus 204 recursively divides map tiles 304-310 into additional smaller map tiles until each map tile is entirely inside polygon 302, entirely outside polygon 302, and/or has reached a minimum map tile size.

As shown in FIG. 3B, mapping apparatus 204 performs two rounds of division related to map tiles 304-310 until a minimum map tile size is reached by map tiles that are intersected by the lower two edges of polygon 302. In one embodiment, the minimum map tile size is selected based on a mode of transportation associated with the commute preference for which polygon 302 was generated. Thus, the minimum map tile size for a walking commute preference is smaller than the minimum map tile size for a cycling commute preference, and the minimum map tile size for the cycling commute preference is smaller than the minimum map tile size for a driving commute preference.

After recursive division of map tiles 304-310 is complete, a number of map tiles 312-338 of varying size are assigned to the geographic area represented by polygon 302. Two larger map tiles 312 and 326 are produced by division of map tiles 304 and 306 into four additional map tiles each. Because map tiles 312 and 326 are found entirely inside the polygon, additional division of map tiles 312 and 326 is omitted, and IDs of 012301 and 0312310 for map tiles 312 and 326 are added to a list of map tiles assigned to the geographic area represented by polygon 302.

A number of map tiles with the same size as map tiles 312 and 326 are divided further into smaller map tiles because the map tiles are intersected by the lower two edges of polygon 302. The smaller map tiles include four map tiles 314, 322, 328, and 336 that are entirely inside polygon 302, which are added to the list of map tiles assigned to the geographic area represented by polygon 302.

The smaller map tiles also include eight map tiles 316, 318, 320, 324, 330, 332, 334, and 338 that are intersected by the boundary of polygon 302. Because map tiles 316, 318, 320, 324, 330, 332, 334, and 338 have reached the minimum map tile size, mapping apparatus 204 assigns map tiles 316, 318, 320, 324, 330, 332, 334, and 338 to the geographic area represented by polygon 302 based on a minimum threshold of 50% coverage of a minimum size map tile by polygon 302.

The same threshold is also used to omit a number of map tiles that are intersected by the boundary of polygon 302 from the geographic area represented by polygon 302. Such map tiles include map tiles to the left of map tiles 318, 320, 324; map tiles to the right of map tiles 332, 334, and 338;

and map tiles below map tiles 324 and 338. Remaining map tiles resulting from the division of map tiles 304-310 (e.g., map tiles with IDs of 012320, 012331, 012322, 012323, 012332, and 012333 and smaller map tiles along the tops and sides of map tiles with IDs of 012320 and 012331) are found entirely outside polygon 302 and are thus excluded from the geographic area represented by polygon 302.

After map tiles 312-338 are assigned to the area represented by polygon 302, mapping apparatus 204 stores IDs of map tiles 312-338 in a prefix tree (e.g., prefix tree 226 of FIG. 2). As shown in FIG. 3C, the top four levels of the prefix tree include nodes with values of 0, 1, 2, and 3, respectively, indicating that all map tiles 312-338 share the same prefix of 0123. The fifth level of the prefix tree includes two nodes with values of 0 and 1 that are connected to the fourth-level node with the value of 3. The sixth level of the prefix tree includes two internal nodes with values of 0 and 3 and one leaf node 346 with a value of 1 connected to the fifth-level node with the value of 0. The sixth level of the prefix tree also includes two internal nodes with values of 1 and 2 and one leaf node 354 with a value of 0 connected to the fifth-level node with the value of 1.

The seventh level of the prefix tree includes four sets of three leaf nodes 340-344, 348-352, 356-360, and 362-366. Leaf nodes 340-344 and 348-352 in the first two sets have values of 0, 1 and 3, and leaf nodes 356-360 and 362-366 in the last two sets have values of 0, 1, and 2. The first set of leaf nodes 340-344 is connected to the sixth-level internal node with the value of 0, the second set of leaf nodes 348-352 is connected to the sixth-level internal node with the value of 3, the third set of leaf nodes 356-358 is connected to the sixth-level internal node with the value of 1, and the fourth set of leaf nodes 362-366 is connected to the sixth-level internal node with the value of 2.

In one or more embodiments, IDs of map tiles 312-338 included in the geographic area of the polygon are represented by paths from the root node of the prefix tree to leaf nodes 340-366. An ID of 012301 for map tile 312 is represented by a path from the root node to leaf node 346, and an ID of 012310 for map tile 326 is represented by a path from the root node to leaf node 354.

An ID of 0123000 for map tile 316 is represented by a path from the root node to leaf node 340, an ID of 0123001 for map tile 314 is represented by a path from the root node to leaf node 342, and an ID of 0123003 for map tile 318 is represented by a path from the root node to leaf node 344. An ID of 0123030 for map tile 320 is represented by a path from the root node to leaf node 348, an ID of 0123031 for map tile 322 is represented by a path from the root node to leaf node 350, and an ID of 0123033 for map tile 324 is represented by a path from the root node to leaf node 352.

An ID of 0123110 for map tile 328 is represented by a path from the root node to leaf node 356, an ID of 0123111 for map tile 330 is represented by a path from the root node to leaf node 358, and an ID of 0123112 for map tile 332 is represented by a path from the root node to leaf node 360. An ID of 0123120 for map tile 336 is represented by a path from the root node to leaf node 362, an ID of 0123121 for map tile 334 is represented by a path from the root node to leaf node 364, and an ID of 0123123 for map tile 338 is represented by a path from the root node to leaf node 366.

In one or more embodiments, the prefix tree of FIG. 3C is serialized and/or encoded in a series of bits, with each node in the prefix tree represented by four bits. The first two bits of the four bits store codes that indicate directions used to traverse the prefix tree via a preorder traversal. The codes include the following:
00: a node exists at the current level; proceed down a level in the traversal
01: a node exists at the current level; proceed up a level in the traversal
10: a node exists at the current level; stay at the same level in the traversal
11: a node does not exist at the current level; proceed up a level in the traversal

The last two bits of the four bits representing each node store the value of the node. That is, a value of 0 is represented by 00, a value of 1 is represented by 01, a value of 2 is represented by 10, and a value of 3 is represented by 11.

In turn, the prefix tree can be represented using the following 13 bytes: 00000001, 00100011, 00000000, 10001001, 01111001, 00111000, 10010111, 11000001, 10000001, 10001001, 01110010, 10001001, 01111111. The first two bytes contain 16 bits that store the values of the top four nodes and reach the fifth level of the prefix tree, and the third byte contains eight bits that store the values of the left-most fifth- and sixth-level nodes of the prefix tree and reach the seventh level of the prefix tree. The fourth byte stores the values of leaf nodes 340-342 and keeps the traversal at the seventh level of the prefix tree, the first half of the fifth byte stores the value of leaf node 344 and returns to the sixth level of the prefix tree, and the second half of the fifth byte stores the value of leaf node 346 and keeps the traversal at the sixth level of the prefix tree. The first half of the sixth byte stores the value of the node to the right of leaf node 346 and descends to the seventh level of the prefix tree, and the second half of the sixth byte and the first half of the seventh byte store the values of leaf nodes 348-350 and keep the traversal at the seventh level of the prefix tree. The second half of the seventh byte stores the value of leaf node 352 and ascends to the sixth level of the prefix tree, and the first half of the eighth byte does not store a node's value and is used to ascend back to the fifth level of the prefix tree.

The second half of the eighth byte stores the value of the right sub-tree at the fifth level and descends to the sixth level, and the first half of the ninth byte stores the value of leaf node 354 and stays at the sixth level. The second half of the ninth byte stores the value of the node to the right of leaf node 354 and descends to the seventh level, and the tenth byte stores the values of leaf nodes 356-358 and keeps the traversal at the seventh level. The first half of the eleventh byte stores the value of leaf node 360 and returns to the sixth level, and the second half of the eleventh byte stores the value of the right sub-tree at the sixth level and descends to the seventh level. The twelfth byte stores the values of leaf nodes 362-364 and keeps the traversal at the seventh level, and the first half of the thirteenth byte stores the value of leaf node 366 and moves the traversal up a level. Finally, the second half of the thirteenth byte is padded with four bits that indicate a lack of a node's value stored within those bits.

In one or more embodiments, the serialized representation of the prefix tree is used to reduce storage and/or expedite comparison of the prefix tree with map tiles and/or other prefix tress. For example, the compact size of the serialized representation allows the prefix tree to be stored in a CPU cache instead of memory. At the same time, tree-based comparison (e.g., determining if a map tile is in the prefix tree and/or if another prefix tree contains map tiles that are fully enclosed by the map tiles in the prefix tree) can be performed using bit shifting and/or bit masking operations, which are must faster than following address pointers to move from one node to another in standard representations of trees.

The prefix tree of FIG. 3C is then compared with a prefix tree representation of an inverted index shown in FIG. 3D to identify jobs that are located in the geographic area denoted by polygon 302. As shown in FIG. 3D, the inverted index includes five nodes 368-376, with paths from the root node to nodes 368-376 representing IDs of map tiles. A path from the root node to node 368 represents an ID of 012300001, a path from the root node to node 370 represents an ID of 012301, a path from the root node to node 372 represents an ID of 0123111, a path from the root node to node 374 represents an ID of 012313, and a path from the root node to node 376 represents an ID of 012311.

Nodes 368-376 map to and/or store IDs of jobs that are found in the corresponding map tiles. Leaf node 368 includes a job ID of 1, leaf node 370 includes job IDs of 2 and 3, leaf node 372 includes a job ID of 2, and leaf nodes 374-376 include a job ID of 4.

In one embodiment, the length of the map tile ID to which each job is mapped indicates the level of granularity, accuracy, and/or certainty associated with the job's location. For example, the map tile ID of 012300001 to which the job ID of 1 is mapped indicates a location represented by an exact address of the corresponding job. Conversely, the shorter map tile IDs to which the job IDs of 2, 3, and 4 are mapped indicate locations represented by street names, zip codes, and/or other lower granularity data (e.g., due to a lack of verified and/or exact address for the corresponding jobs).

Management apparatus 206 performs a first pass of the prefix tree of FIG. 3C and the inverted index of FIG. 3D to identify a set of jobs with at least one map tile in the area represented by the prefix tree. During the first pass, management apparatus 206 scans both prefix trees in the same order (e.g., in a pre-order traversal). When a leaf node in the prefix tree of FIG. 3C is reached, any jobs in a sub-tree of the leaf node that are found in the index are included in the set of jobs. Because leaf nodes 368-372 represent sub-trees of nodes in the prefix tree of FIG. 3C, jobs with IDs of 1, 2, and 3 are added to the set.

When a map tile in the inverted index is partially covered by the prefix tree of FIG. 3C, a threshold is applied to the coverage to determine whether or not to add jobs to which the map tile is mapped to the set. For example, a threshold of 75% coverage allows the job ID of 4 to be added to the set, since the corresponding map tile with the ID of 012311 has three out of four sub-tiles in the prefix tree of FIG. 3C.

On the other hand, the inverted index also includes a mapping of map tile ID 012313 to the same job ID of 4. Because map tile ID 012313 is not found in the prefix tree of FIG. 3C, the location of the job encompasses an area that does not meet the 75% threshold.

To identify and remove such jobs from the set, management apparatus 206 performs a second pass of the prefix tree of FIG. 3C with a forward index that maps job IDs to map tile IDs of map tiles representing the jobs' locations. To achieve space and/or memory savings and expedite comparison with the prefix tree of FIG. 3C, one or more map tile IDs to which each job ID is mapped in the forward index are stored as a series of bits using the encoding described above. In turn, bitwise comparisons of map tile IDs in the forward index with the prefix tree of FIG. 3C indicate that the prefix tree does not include map tile ID 012313 to which job ID 4 is mapped, and the job is removed from the set.

Returning to the discussion of FIG. 2, after management apparatus 206 identifies a set of jobs with locations that overlap with map tiles 224 representing polygon 222 beyond a threshold proportion or percentage, management apparatus 206 uses isochrones 242 to calculate transit times 244 between the candidate associated with polygon 222 and the jobs. Management apparatus 206 also, or instead, estimates transit times 244 for jobs independently of performing location-based searches for the jobs using polygon 222. For example, management apparatus 206 includes functionality to estimate transit times 244 between a candidate and a set of jobs that fall within a given map tile (e.g., a map tile that bounds all isochrones 242 associated with the candidate's commute preferences 240).

As mentioned above, isochrones 242 include geographic representations of transit time thresholds for the candidate. To determine transit times 244, management apparatus 206 orders isochrones 242 from smallest to largest transit time threshold and compares the locations of the jobs to the boundaries of the ordered isochrones 242. When a job's location is found to be inside a given isochrone, the job's transit time set to the transit time threshold represented by the isochrone.

In an exemplary embodiment, management apparatus 206 orders three isochrones 242 by the corresponding transit time thresholds of 5 minutes, 10 minutes, and 20 minutes for a user and/or candidate with commute preferences 240 that include a maximum or preferred transit time of 20 minutes. Management apparatus 206 uses a ray-casting technique, a winding number technique, a grid-based technique, and/or another technique for determining whether a point lies inside or outside a polygon to compare the jobs' locations to the first isochrone representing the 5-time transit time threshold. When management apparatus 206 finds a job that is inside the first isochrone, management apparatus 206 sets the transit time for the job to 5 minutes. Management apparatus 206 repeats the comparison with the second isochrone representing the 10-minute time transit threshold and jobs that were found to be outside the first isochrone. After the comparison, management apparatus 206 sets transit times 244 of 10 minutes for jobs found to be inside the second isochrone. Finally, management apparatus 206 performs the comparison one more time with the third isochrone representing the 20-minute transit time threshold and jobs that were found to be outside the first and second isochrones 242. Management apparatus 206 then sets transit times 244 of 20 minutes for jobs found to be inside the third isochrone.

In other words, management apparatus 206 uses computationally efficient comparisons of job locations with isochrones 242 representing the user's commute preferences 240 to estimate transit times 244 between a user and the jobs instead of incurring much greater computational overhead in calculating a route between the user and each job and determining the transit time associated with the route. As a result, management apparatus 206 is able to scale estimation of personalized transit times 244 to a large number of users, commute preferences 240, and/or jobs (or other entities).

Management apparatus 206 generates and/or outputs recommendations 246 based on transit times 244 and/or other results of comparisons involving job locations and polygon 222 and/or map tile representations of geographic areas. In one example, management apparatus 206 returns a set of jobs that are located in a set of map tiles 224 representing a geographic area covered by a given polygon 222 and/or set of polygons. Management apparatus 206 and/or another component optionally rank the jobs by compatibility, relevance, and or transit time for a user associated with the polygon(s) (e.g., a candidate with commute preferences 240 that are represented by the polygon(s)). The component then outputs some or all of the jobs and/or ranked jobs as recommendations 246 to the user. In another example, management apparatus 206 displays transit times 244 for a set of jobs that are recommended to a user and/or during browsing or searching of the jobs by the user to allow the user to use transit times 244 in evaluating the attractiveness of the jobs and/or the compatibility of the jobs with the user's preferences.

By using isochrones related to a candidate's transit time preference to identify jobs with transit times that meet the transit time preference, the disclosed embodiments allow job searches and/or job recommendations to be tailored to the candidate's commute preferences. In turn, the candidate is able to avoid having to manually look up routes to the jobs to determine commute times for the jobs. At the same time, the use of isochrones to estimate transit times between starting points associated with users (e.g., candidates) and entities (e.g., jobs) enable scaling of the estimates to a large number of user-entity pairs.

By mapping polygons to map tiles and retrieving jobs and/or other entities that are indexed by the map tiles, the disclosed embodiments further allow location-based searches related to the jobs and/or entities to be performed within arbitrarily defined geographic areas. In addition, the use of prefix tree representations of the map tiles to identify entities that are located in the polygons reduces computational complexity over naïve techniques that perform one-to-one matching of map tiles in geographic areas to locations of entities. Consequently, the disclosed embodiments improve computer systems, applications, user experiences, tools, and/or technologies related to location-based search, route planning, user recommendations, employment, recruiting, and/or hiring.

Those skilled in the art will appreciate that the system of FIG. 2 may be implemented in a variety of ways. First, mapping apparatus 204, indexing apparatus 210, management apparatus 206, and/or data repository 134 may be provided by a single physical machine, multiple computer systems, one or more virtual machines, a grid, one or more databases, one or more filesystems, and/or a cloud computing system. Mapping apparatus 204, indexing apparatus 210, and management apparatus 206 may additionally be implemented together and/or separately by one or more hardware and/or software components and/or layers.

Second, the system may be adapted to location-based searches and/or estimation of transit times 244 for various types of users and/or entities. For example, the system obtains transit preferences that include homes, schools, jobs, cities, airports, businesses, and/or other types of entities as starting points. The system identifies additional entities that are within a certain time-based geographic boundary of the starting points, uses isochrones 242 related to the transit preferences calculate transit times 244 between the starting points and the additional entities, and/or recommends a subset of entities with transit times 244 that meet one or more thresholds to users associated with the transit preferences.

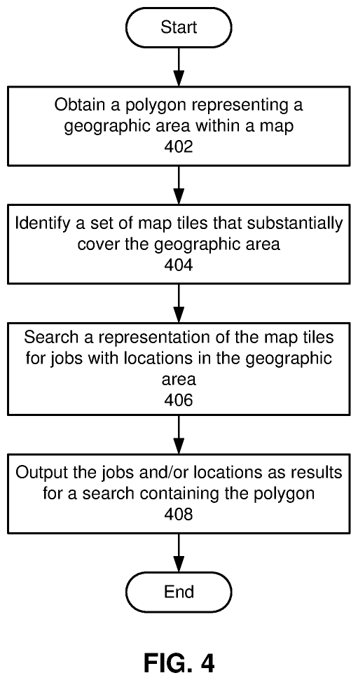

FIG. 4 shows a flowchart illustrating a process of searching by commute preference in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a polygon representing a geographic area within a map is obtained (operation 402). For example, the polygon is represented as an ordered list of vertices, with edges connecting consecutive vertices in the list. The list of vertices is optionally downsampled to fall within a maximum number of vertices to limit the size and/or complexity of the polygon. In another example, the polygon represents an isochrone that is generated based on a starting point, mode of transportation, transit time preference, start time, and/or other criteria associated with commute or transit preferences of a user or candidate. In a third example, the polygon includes a user-defined and/or hand-drawn area within a map that defines a geographic area of interest for the corresponding user.

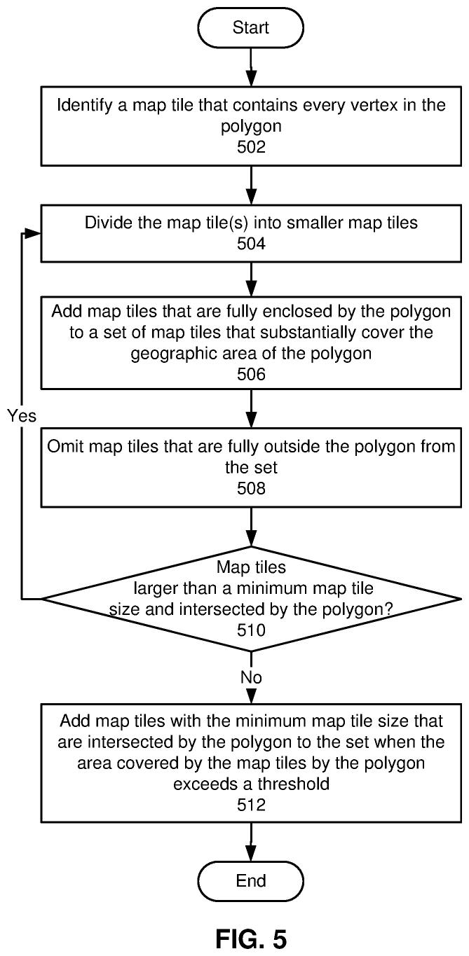

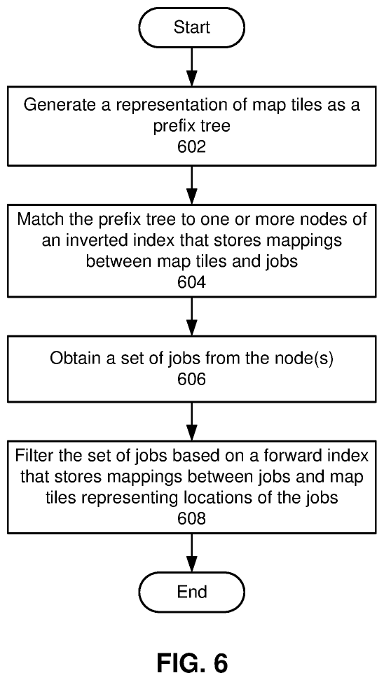

Next, a set of map tiles that substantially cover the geographic area of the polygon is identified (operation 404), as described in further detail below with respect to FIG. 5. A representation of the map tiles is then searched for a set of jobs with locations in the geographic area (operation 406), as described in further detail below with respect to FIG. 6. The map tiles are also, or instead, used to search for other types of entities (e.g., restaurants, schools, businesses, hospitals, parks, residences, landmarks, etc.) that are within a geographic area denoted by the polygon.

Finally, the jobs and/or locations are outputted as results for a search containing the polygon (operation 408). For example, the jobs and/or locations are returned as results of the search, and a ranking of the jobs may be outputted to a user performing the search.

FIG. 5 shows a flowchart illustrating a process of identifying map tiles that cover a geographic area of a polygon in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First a map tile that contains every vertex in the polygon is identified (operation 502). For example, the map tile may be identified by matching a vertex in the polygon to a map tile in which the vertex is found and expanding the size of the map tile until all vertices in the polygon are included in the map tile. Next, the map tile is divided into smaller map tiles (operation 504). For example, a larger square map tile may be divided into four smaller square map tiles that occupy the four quadrants of the larger map tile.

Map tiles that are fully enclosed by the polygon are added to a set of map tiles that substantially cover the geographic area of the polygon (operation 506), and map tiles that are fully outside the polygon are omitted from the set (operation 508). Remaining map tiles may be larger than a minimum map tile size and intersected by the polygon (operation 510). When such map tiles exist, the map tile(s) are further divided into smaller map tiles (operation 504), and the smaller map tiles are added to the set or omitted from the set according to the map tiles' positions with respect to the polygon (operations 506-508).

Operations 504-508 may be repeated while map tiles that are larger than the minimum map tile size are still intersected by the polygon (operation 510). When the divided map tiles reach the minimum map tile size and are still intersected by the polygon, such map tiles are added to the set when the area covered by the map tiles by the polygon exceeds a threshold (operation 512). For example, a minimum-size map tile is added to the set if the polygon covers more than 50% or 75% of the area of the map tile. The set can then be used to retrieve jobs (or other entities) with locations in the map tiles, as described in further detail below with respect to FIG. 6.

FIG. 6 shows a flowchart illustrating a process of searching a representation of map tiles for jobs with locations in a geographic area represented by the map tiles in accordance with the disclosed embodiments. In one or more embodiments, one or more of the steps may be omitted, repeated, and/or performed in a different order. Accordingly, the specific arrangement of steps shown in FIG. 6 should not be construed as limiting the scope of the embodiments.

First, the representation of the map tiles is generated as a prefix tree (operation 602). In one embodiment, IDs of the map tiles are structured so that the ID of a larger map tile is the prefix of the ID of a smaller map tile that is found within the larger map tile. Thus, the prefix tree reduces overhead associated with storing and/or representing the set of map tiles by allowing a single prefix to be stored once for all map tiles with that prefix, and additional digits that are unique to a given map tile to be appended to the shared prefix. In one embodiment, each node in the prefix tree is further represented using a series of bits, which includes one or more bits that encode a value of the node and one or more additional bits that encode a traversal direction associated with the node.

Next, the prefix tree is matched to one or more nodes of an inverted index that stores mappings between map tiles and jobs (operation 604). For example, the prefix tree may be compared to the inverted index to identify nodes in the inverted index associated with sub-trees of the prefix tree. A set of jobs is then obtained from the nodes (operation 606). For example, IDs of the jobs are obtained from mappings stored in and/or associated with the identified nodes.

Finally, the set of jobs is filtered based on a forward index that stores mappings between the jobs and map tiles representing locations of the jobs (operation 608). For example, a lookup of the forward index may be performed for each job in the set to retrieve a set of map tile IDs to which the job's ID is mapped. If any of the map tile IDs are not found in the prefix tree, the job is removed from the set. Alternatively, map tile IDs to which the job is mapped are evaluated to determine the coverage of the map tile IDs by the prefix tree. If more than a threshold area represented by the map tile ID is covered by map tile IDs in the prefix tree, the job may be kept in the set.

In one embodiment, operations 602-608 are adapted for retrieval of other types of entities (e.g., schools, restaurants, hospitals, parks, homes, businesses, airports, parking facilities, etc.) with locations in the geographic area represented by the map tiles. Thus, the inverted index may map from map tile IDs to IDs of the entities, and the forward index may map from IDs of the entities to the map tile IDs.

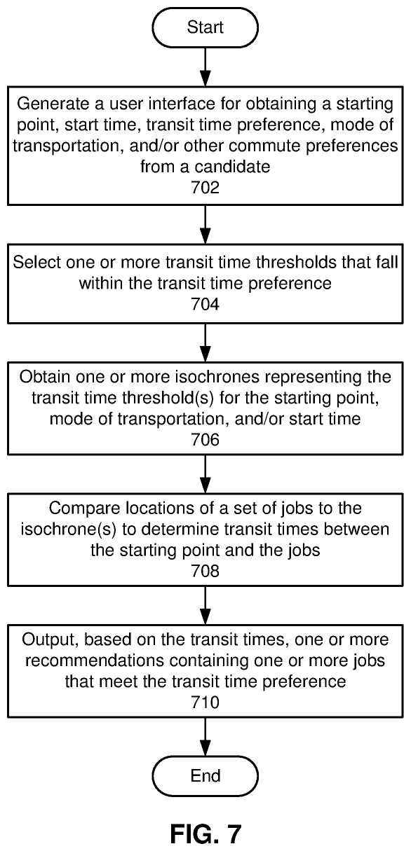

FIG. 7 shows a flowchart illustrating a process of estimating transit times between a candidate and a set of jobs in accordance with the disclosed embodiments. In one or more embodiments, one or more of the steps may be omitted, repeated, and/or performed in a different order. Accordingly, the specific arrangement of steps shown in FIG. 7 should not be construed as limiting the scope of the embodiments.

Initially, a user interface for obtaining a starting point, start time, transit time preference, mode of transportation, and/or other commute preferences from a candidate is generated (operation 702). In one embodiment, the user interface includes a web-based user interface, graphical user interface, voice user interface, and/or another type of user interface that interacts with the candidate to obtain the candidate's commute preferences.

Next, one or more transit time thresholds that fall within the transit time preference are selected (operation 704). In one embodiment, the transit time thresholds include numeric values representing transit time limits up to the transit time preference. The numeric values are selected based on the transit time preference, mode of transportation, and/or additional commute preferences of the candidate and/or other users (e.g., common user preferences for limits to transit times).

One or more isochrones representing the transit time threshold(s) are obtained for the starting point, mode of transportation, and/or start time (operation 706). In one embodiment, each isochrone is generated as a geographic boundary for a corresponding transit time threshold (i.e., the distance that can be traveled without exceeding the transit time threshold), given the starting point, start time, and/or mode of transportation.

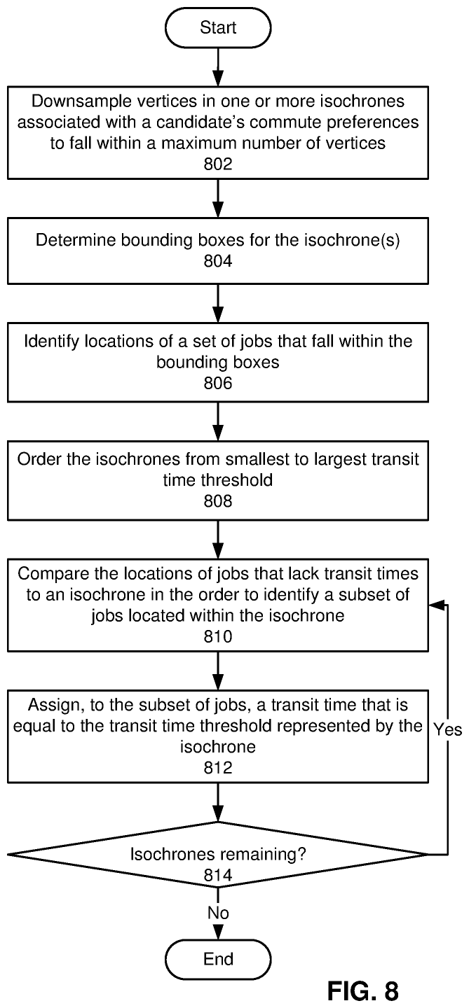

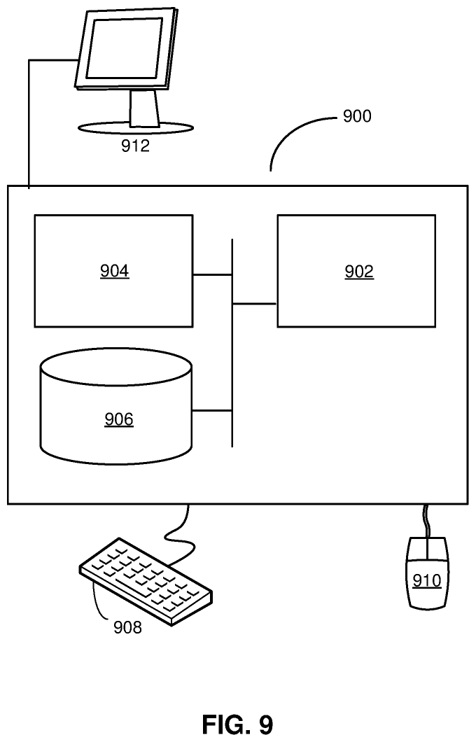

Locations of a set of jobs are compared to the isochrone(s) to determine transit times between the starting point and the jobs (operation 708), as described in further detail below with respect to FIG. 8. Finally, one or more recommendations containing one or more jobs that meet the transit time preference are outputted based on the transit times (operation 710). In some embodiments, the recommendations include a subset of the jobs that meet the transit time preference and/or a transit time between the starting point and a job that meets the transit time preference.

FIG. 8 shows a flowchart illustrating a process of using isochrones to determine transit times between a candidate and a set of jobs in accordance with the disclosed embodiments. In one or more embodiments, one or more of the steps may be omitted, repeated, and/or performed in a different order. Accordingly, the specific arrangement of steps shown in FIG. 8 should not be construed as limiting the scope of the embodiments.

First, vertices in one or more isochrones associated with a candidate's commute preferences are downsampled to fall within a maximum number of vertices (operation 802). For example, the isochrones are generated using a large number of vertices. To reduce the overhead associated with storing and/or processing the isochrones, a Douglas-Peucker technique, Visvalingam-Whyatt technique, and/or another line-simplification technique is used to reduce the number of vertices in each isochrone while maintaining reasonable accuracy in the shape of the isochrone.

Next, bounding boxes for the isochrone(s) are determined (operation 804). The bounding boxes include, but are not limited to, a single map tile and/or other rectangular box that includes all vertices in a given isochrone, a set of map tiles that substantially covers the geographic area represented by the isochrone (e.g., as determined using the process described with respect to FIG. 5), and/or another representation of an area that is larger than the isochrone.

Locations of a set of jobs that fall within the bounding boxes are identified (operation 806). For example, job locations inside the bounding boxes are identified using an inverted index that stores mappings of map tiles representing the bounding boxes to IDs and/or locations of the jobs. In another example, the boundaries of the bounding boxes are used to retrieve jobs with coordinates inside the bounding boxes.

The isochrones are ordered from smallest to largest transit time threshold (operation 808), and the locations of jobs that lack transit times are compared to an isochrone in the order to identify a subset of jobs located within the isochrone (operation 810). The subset of jobs is then assigned a transit time that is equal to the transit time threshold represented by the isochrone (operation 812). For example, a ray-casting and/or other technique for determining the location of a point relative to a polygon are used to identify a subset of jobs located in the isochrone with the smallest transit time threshold, and the transit time for the subset of jobs is assigned to the smallest time transit threshold.

Operations 810-812 are then repeated for any remaining isochrones (operation 814) in the ordered isochrones. For each isochrone, remaining jobs that have not been assigned transit times (i.e., jobs that are outside previous isochrones with smaller time transit thresholds) are compared to the isochrone, and jobs that are found to be inside the isochrone are assigned a transit time corresponding to the transit time threshold represented by the isochrone. The jobs' locations and/or transit times are then used to generate and/or output recommendations related to the candidate's transit preferences, as discussed above.

In one or more embodiments, operations 802-814 are adapted for use in estimating transit times between a user and other entities (e.g., schools, restaurants, hospitals, parks, homes, businesses, airports, parking facilities, etc.) based on the user's transit preferences. In these embodiments, locations of entities that fall within the bounding boxes are identified and compared with isochrones representing transit preferences of the user, and transit times between the user and the entities are assigned to transit time thresholds associated with the isochrones.

FIG. 9 shows a computer system 900 in accordance with an embodiment. Computer system 900 may correspond to an apparatus that includes a processor 902, memory 904, storage 906, and/or other components found in electronic computing devices. Processor 902 may support parallel processing and/or multi-threaded operation with other processors in computer system 900. Computer system 900 may also include input/output (I/O) devices such as a keyboard 908, a mouse 910, and a display 912.

Computer system 900 may include functionality to execute various components of the present embodiments. In particular, computer system 900 includes an operating system (not shown) that coordinates the use of hardware and software resources on computer system 900, as well as one or more applications that perform specialized tasks for the user. To perform tasks for the user, applications obtain the use of hardware resources on computer system 900 from the operating system and interact with the user through a hardware and/or software framework provided by the operating system.

In one or more embodiments, computer system 900 provides a system for estimating transit times and/or searching by commute preference. The system includes a mapping apparatus, a management apparatus, and an indexing apparatus, one or more of which may alternatively be termed or implemented as a module, mechanism, or other type of system component. The management apparatus selects one or more transit time thresholds that fall within a transit time preference for a user. Next, the management apparatus obtains one or more isochrones representing the one or more transit time thresholds for a starting point associated with the user and a mode of transportation. The management apparatus then compares locations of a set of entities (e.g., jobs) to the one or more isochrones to calculate transit times between the starting point and the set of entities. Finally, the management apparatus outputs, based on the transit times, one or more recommendations comprising one or more entities in the set of entities that meet the transit time preference.

The mapping apparatus obtains a polygon representing a geographic area within a map. Next, the mapping apparatus identifies a set of map tiles that substantially cover the geographic area of the polygon. The management apparatus then searches a prefix tree representation of the set of map tiles and/or an index provided by the indexing apparatus for a set of entities (e.g., jobs) with locations in the geographic area. Finally, the management apparatus outputs the locations of the set of entities as location-based matches for a search comprising the polygon.

In addition, one or more components of computer system 900 may be remotely located and connected to the other components over a network. Portions of the present embodiments (e.g., mapping apparatus, indexing apparatus, management apparatus, data repository, online network, etc.) may also be located on different nodes of a distributed system that implements the embodiments. For example, the present embodiments may be implemented using a cloud computing system that generates location-based search results and/or transit times for a set of remote users.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used Implementation of these embodiments is not intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
selecting one or more transit time thresholds that fall within a transit time preference for a candidate;
obtaining, by one or more computer systems, one or more isochrones representing the one or more transit time thresholds for a starting point associated with the candidate and a mode of transportation;
comparing, by one or more computer systems, locations of a set of jobs to the one or more isochrones to determine transit times between the starting point and the set of jobs; and
outputting, based on the transit times, one or more recommendations comprising one or more jobs in the set of jobs that meet the transit time preference.

2. The method of claim 1, wherein obtaining the one or more isochrones comprises:
downsampling vertices in the one or more isochrones to fall within a maximum number of vertices.

3. The method of claim 1, wherein comparing the locations of the set of jobs to the one or more isochrones to determine the transit times between the starting point and the set of jobs comprises:
determining bounding boxes for the one or more isochrones; and
identifying the locations of the set of jobs as falling within the bounding boxes.

4. The method of claim 3, wherein the bounding boxes comprise at least one of:
a bounding box for a polygon in an isochrone; and
a set of map tiles that substantially cover a geographic area represented by the isochrone.

5. The method of claim 1, wherein comparing the locations of the set of jobs to the one or more isochrones to determine the transit times between the starting point and the set of jobs comprises:
comparing the locations of the set of jobs to a first isochrone that represents a smallest transit time threshold to identify a first subset of the jobs located within the first isochrone; and
assigning, to the first subset of jobs, a first transit time that is equal to the smallest transit time threshold.

6. The method of claim 5, wherein comparing the locations of the set of jobs to the one or more isochrones to determine the transit times between the starting point and the set of jobs further comprises:
comparing remaining locations of the set of jobs that are outside the first isochrone to a second isochrone that represents a larger transit time threshold than the smallest transit time threshold to identify a second subset of jobs located within the second isochrone; and
assigning, to the second subset of jobs, a second transit time that is equal to the larger transit time threshold.

7. The method of claim 1, wherein comparing the locations of the set of jobs to the one or more isochrones to determine the transit times between the starting point and the set of jobs comprises:
applying a ray-casting technique to the locations of the set of jobs and an isochrone to identify a subset of the jobs located within the isochrone.

8. The method of claim 1, wherein the one or more recommendations comprise a subset of the jobs that meet the transit time preference.

9. The method of claim 1, wherein the one or more recommendations comprise a transit time between the starting point and a job that meets the transit time preference.

10. The method of claim 1, further comprising:
generating a user interface for obtaining the starting point, a start time, the transit time preference, and the mode of transportation from the candidate.

11. The method of claim 1, wherein the one or more transit time thresholds comprise at least one of:
a first transit time threshold that equals the transit time preference; and
a second transit time threshold that is less than the transit time preference.

12. A system, comprising:
one or more processors; and
memory storing instructions that, when executed by the one or more processors, cause the system to:
select one or more transit time thresholds that fall within a transit time preference for a user;
obtain one or more isochrones representing the one or more transit time thresholds for a starting point associated with the user and a mode of transportation;
compare locations of a set of entities to the one or more isochrones to calculate transit times between the starting point and the set of entities; and
output, based on the transit times, one or more recommendations comprising one or more entities in the set of entities that meet the transit time preference.

13. The system of claim 12, wherein comparing the locations of the set of entities to the one or more isochrones to determine the transit times between the starting point and the set of entities comprises:
comparing the locations of the set of entities to a first isochrone that represents a smallest transit time threshold to identify a first subset of the entities located within the first isochrone; and
assigning, to the first subset of entities, a first transit time that is equal to the smallest transit time threshold.

14. The system of claim 13, wherein comparing the locations of the set of entities to the one or more isochrones to determine the transit times between the starting point and the set of entities further comprises:
comparing remaining locations of the set of entities that are outside the first isochrone to a second isochrone that represents a larger transit time threshold than the smallest transit time threshold to identify a second subset of entities located within the second isochrone; and
assigning, to the second subset of entities, a second transit time that is equal to the larger transit time threshold.

15. The system of claim 12, wherein comparing the locations of the set of entities to the one or more isochrones to determine the transit times between the starting point and the set of entities comprises:
applying a ray-casting technique to the locations of the set of entities and an isochrone to identify a subset of the entities located within the isochrone.

16. The system of claim 12, wherein the memory further stores instructions that, when executed by the one or more processors, cause the system to:
identify a set of map tiles that substantially cover the one or more isochrones; and
search a prefix tree representation of the set of map tiles for the set of entities.

17. The system of claim 12, wherein the one or more recommendations comprise at least one of:
a subset of the entities that meet the transit time preference; and
a transit time between the starting point and an entity that meets the transit time preference.

18. The system of claim 12, wherein the set of entities comprises at least one of:
a job;
a business;
a school;
a park; and
a residence.

19. A non-transitory computer-readable storage medium storing instructions that when executed by a computer cause the computer to perform a method, the method comprising:
selecting one or more transit time thresholds that fall within a transit time preference for a candidate;
obtaining one or more isochrones representing the one or more transit time thresholds for a starting point associated with the candidate and a mode of transportation;
comparing locations of a set of jobs to the one or more isochrones to determine transit times between the starting point and the set of jobs; and
outputting, based on the transit times, one or more recommendations comprising one or more jobs in the set of jobs that meet the transit time preference.

20. The non-transitory computer-readable storage medium of claim 19, wherein comparing the locations of the set of jobs to the one or more isochrones to determine the transit times between the starting point and the set of jobs comprises:
comparing the locations of the set of jobs to a first isochrone that represents a smallest transit time threshold to identify a first subset of the jobs located within the first isochrone;
assigning, to the first subset of jobs, a first transit time that is equal to the smallest transit time threshold;
comparing remaining locations of the set of jobs that are outside the first isochrone to a second isochrone that represents a larger transit time threshold than the smallest transit time threshold to identify a second subset of jobs located within the second isochrone; and
assigning, to the second subset of jobs, a second transit time that is equal to the larger transit time threshold.
